(19) United States
(12) Patent Application Publication
(10) Pub. No.: US 2010/0123552 A1
(43) Pub. Date: May 20, 2010

(54) Tow notification system

(76) Inventors: Richard Dana Kaufman, North Adover, MA (US); Edward K. Welch, II, Naples, FL (US)

Correspondence Address: EDWARD K. WELCH II;IP&L Solution, 4558 Ashton Court, Naples, FL, 34112, US

(21) Appl. No.: 12/313,403

(22) Filed: Nov. 20, 2008

(51) Int. Cl. H04Q 5/22

(52) U.S. Cl. 340/10.1

(57) ABSTRACT

A system for and method by which persons associated with a vehicle are notified of the towing of that vehicle.

### FIELD OF THE INVENTION

The present invention relates to a tow notification system and associated notification process. Specifically, the present invention relates to a system and process whereby the owner or its designee is provided with an alert notification that a vehicle is being towed and the location or contact information for the tow provider.

### BACKGROUND

Across the globe, on any given day, numerous vehicles are involuntarily towed for any of a number of reasons at the request of private landowners, property manages or public/municipal servants. For example, a vehicle operator may have inadvertently, unintentionally or, even, intentionally parked the vehicle they are operating on private property without permission and the property owner, occupant or manager may call a tow service to have the vehicle removed. More commonly, vehicles are towed at the request of public/municipal servants, e.g., police, traffic control officers, fire departments, municipal service providers, parking lot attendants, parking lot enforcement officers, etc. For example, vehicles may be parked in no parking areas or tow zones or parked on a route at a time when no parking is allowed, e.g., on a scheduled cleaning day or during a snow emergency. They may be parked so as to obstruct traffic, access to property, or to fire hydrants, and the like. Alternatively, a vehicle may not be properly registered or have numerous outstanding fines and, since parking space is oftentimes limited, rather than booting the vehicle, it may be towed.

In smaller towns and municipalities, there are oftentimes only a few tow operators, perhaps only one that services the local municipality or government itself. In this situation, once one determines whether the vehicle was towed, a process of elimination can be used to locate the proper towing service and location of the vehicle. In larger municipalities, especially larger cities, however, it is not quite so simple. Larger municipalities and communities have numerous tow operators. If the towing occurred at the request of a private individual or entity, it is anyone's guess as to where the vehicle may be. If the towing occurred at the request of a public servant or by the municipality itself, the number of tow operators contracted by the local government or municipal entity may be large and each may have multiple lots. In a large city, again, it is anyone's guess as to where a vehicle may be towed depending upon which tow operator towed the vehicle, where their lots are, what the status of their lots are and the like. Vehicles are not always towed to the most convenient location since that location may be full or have other issues. If there is a competitive towing environment, it may be the first tow operator that arrives that gets the tow, regardless of the proximity of their lot to the vehicle to be towed.

While the logistics of the tow operation lie with the tow operator/provider, the reality is that the operator or owner of the vehicle, upon returning to their vehicle, merely sees that it is no longer parked where they thought they had left it. Perhaps, they'll walk around a bit to ensure themselves that they didn't forget where they left the vehicle. Ultimately, though, the thought goes to the vehicle as having been stolen or towed, most likely the former. While some vehicle owners/operators may handle the situation calmly, the more likely response is one of being panic stricken. Then an anxious call is made to the police to report the vehicle as stolen. In a large city where numerous tow operations occur on a nearly continuous basis, the number of calls to the police combined with the need to look up the information can be a nuisance or distraction from the true public safety objective of the police. If the police are unaware of the towing of the vehicle, time and energy of the owner of the vehicle as well as the police department are unnecessarily consumed in preparing stolen vehicle reports, alerting units to the stolen vehicle, etc.

One would hope that tow operators, after making the tow, would notify the local police of the occurrence of the tow; however, one cannot be sure. This may not be too much of a problem in small towns since they tend to have few tow operators and typically a single police station. However, in larger municipalities and cities, as noted above, there are typically multiple tow operators and many precincts or police substations. Even if local laws or regulations require that a tow operator notify the local police of a towing operation, there is no guarantee that it may not be overlooked, that it will be handled in a prompt manner or that the information will accurately be transmitted to or recorded by the police. Furthermore, in large municipalities and cities where multiple precincts exist, even if a call informing of a tow is placed to one precinct, one cannot be sure how long it will take before other precincts are notified. The situation is further exacerbated in areas where multiple agencies have jurisdiction over a given location, e.g., local, metropolitan, county and state police; airport security; federal agencies; state motor vehicle officers, etc. Here, it is not merely a question of how accurately and quickly the information is loaded into that agency's records or database, but whether and how quickly, if at all, such information is made known or available to other agencies having authority within that area.

All the while, if the police or other agency called by the owner or operator of the vehicle are unable to provide an immediate response, the vehicle owner/operator is left to panic over the whereabouts of their vehicle. If they've left personal items in the vehicle, especially credit cards or other documents and information that would be of interest to thieves or facilitators/conductors of identify theft, one must begin the arduous and painstaking task of notifying the appropriate service providers of the possible theft. Additionally, one must make arrangements to get back to their home. If one is traveling or far from home, one must make alternative arrangements to return to their home or wherever they may be staying. If one is in en-route to a vacation, event or the like, such may cause one to have to cancel their plans. Additionally, since many tow lots charge a daily fee for the storage of a vehicle, if an individual is unaware that their vehicle has been towed, e.g., a person who is away on an extended trip or who uses their vehicle only infrequently, sizable storage fees could amass before the vehicle is recovered.

Thus, there is a need for a simple system and process by which an owner/operator of a vehicle can be notified of the towing of their vehicle.

Further, there is a need for a simple system and process by which an owner/operator of a vehicle can be promptly notified of the towing of their vehicle, perhaps even before they realize or become aware that the vehicle is no longer where they left it.

There is a need for such a notification system and process that has minimal reliance upon one or more individuals and, accordingly, avoids or minimizes the impact of human inaction, procrastination and/or error.

There is a need for such a notification system and process that minimizes any impact on the operations and function of public safety organizations, especially police departments and the like.

### SUMMARY OF THE INVENTION

In accordance with the present invention there is provided a tow notification system comprising
a) an indicator on a motor vehicle indicative of identifier information pertaining to one or more contact persons associated with the vehicle,
b) a repository possessing or having access to a database containing correlation information matching the identifier information with the contact information for the contact persons,
c) a first communication means for transmitting the identifier information to the repository when said vehicle is or is about to be towed, and
d) a second communication means for alerting the contact person to the towing of the motor vehicle.

In following, the present invention also provides a process pursuant to which a contact person for a motor vehicle is notified of the towing of their vehicle said process comprising the steps of:
a) retrieving identifier information from the vehicle,
b) transmitting the identifier information to a repository having or having access to a database containing correlation information for matching the identifier information to one or more contact persons for the vehicle,
c) correlating said identifier information with the contact information for the one or more contact persons, and
d) sending an alert to at least one of said contact persons wherein said alert either contains at least one of the identity, location or contact number of the facility to which the vehicle has been towed or contains a contact number to be called so that the aforementioned information can be retrieved. Most preferably, the alert will include some indication that a towing has occurred so that the recipient of the alert will pay attention to the same.

According to one embodiment of the present invention, a tow operator, who may be the operator of the tow truck or a person at the tow storage facility, will have a portable scanner that is capable or reading or scanning the indicator on the vehicle in order to retrieve the identifier information. The scanned identifier information is then directly or indirectly transmitted to a repository where the identifier information is recorded and correlated with contact information stored in a database to match the motor vehicle to one or more contact persons associated therewith. The repository then automatically or manually sends an alert to the contact person notifying them that the vehicle has been towed and at least one of the identity, location or contact number of the facility to which the vehicle has been towed. Alternatively, the alert may merely indicate “tow alert” or something along those lines together with a contact number to be called so that the aforementioned tow facility information can be retrieved. The latter contact number could be for the tow facility, the repository, or another entity engaged to be part of the system and notification process.

In accordance with another embodiment, the motor vehicle includes an electronic device that is capable of transmitting an electronic signal containing the identifier information. This electronic signal is received by a second electronic device located at or near the entry to the facility to which the vehicle is being or has been towed whereupon, upon entry of the towed vehicle into the facility, the identifier signal from the motor vehicle is received by the electronic device at the facility and subsequently transmitted to the repository. Once again, the transmitted identifier information will be matched up with the contact information for the contact person(s) associated with that motor vehicle and that contact person notified as appropriate.

### DETAILED DESCRIPTION

The present invention provides for a tow notification system comprising
a) an indicator on a motor vehicle indicative of identifier information pertaining to one or more contact persons associated with the vehicle,
b) a repository possessing or having access to a database containing correlation information matching the identifier information with the contact information for the contact persons,
c) a first communication means for transmitting the identifier information to the repository when said vehicle is or is about to be towed, and
d) a second communication means for alerting the contact person to the towing of the motor vehicle.

The foregoing system is employed in order to notify one or more contact persons associated with a vehicle to the towing of that vehicle.

In following, the present invention also provides for a tow notification process, the notification process comprising the steps of:
a) retrieving identifier information from the vehicle,
b) transmitting the identifier information to a repository having or having access to a database containing correlation information for matching the identifier information to one or more contact persons for the vehicle,
c) correlating said identifier information with the contact information for the one or more contact persons, and
d) sending an alert to at least one of said contact persons wherein said alert either contains at least one of the identity, location or contact number of the facility to which the vehicle has been towed or contains a contact number to be called to so that the aforementioned information can be retrieved. Most preferably, the alert will include some indication that a towing has occurred so that the recipient of the alert will pay attention to the same.

The contact person or persons for any given vehicle may be any of a number of persons. For a typical private vehicle, the contact person is most likely the owner or registrant of that vehicle. However, it is to be appreciated that the primary operator of a vehicle may be other than the owner or registrant, for example, an immediate family member or a relative, in which case the latter may be the contact person. In the case of commercial or fleet vehicles, the contact person may be a fleet manager or, if a given vehicle is consistently assigned to the same person, the contact person may be the person to whom the vehicle is assigned.

In most instances, especially where the tow notification systems is operated by a private enterprise as a pay for service business, the contact person or persons and relevant contact information will be included as part of the service application process and will be designated by the applicant at the time or signing up for the service or as subsequently revised. Alternatively, especially if the tow notification service is to be offered by a municipality or other governmental agency, the contact information may be derived from the vehicle registration information.

The indicator on the vehicle indicative of the identifier information may be the vehicle registration, the vehicle identification number (VIN) or, to the extent it is unique, the state inspection sticker. In this case, especially if the tow notification service is provided by a private enterprise, the vehicle will also have a sticker, decal, logo, trim, or other visible insignia indicative of the proper repository to be contacted.

Alternatively, the indicator may comprise another type of insignia or marking comprising a unique identifier that is assigned to the vehicle. For example, it may comprise a sticker, decal, trim piece, or other insignia that is applied to the vehicle and that contains one or more unique numerical, alphabetical, alphanumerical symbols or markings, one or more bar codes, and the like, or combinations thereof. Typically, such stickers, decals, trim pieces, and the like will be issued by a private enterprise and will include or have associated therewith or embedded therein information pertaining to the identity (e.g., the logo) and/or contact information for the appropriate repository. For example, if an enterprise like AAA were the provider of the tow notification service, the indicator may also have the AAA logo and/or contact information or one or more portions of the bar code, if present, may be representative of AAA. In the latter instance, the bar code could contain contact information for AAA whereby the bar code scanner, or a communications device connected thereto, automatically makes a connection with the AAA repository. Inclusion of some indication of the repository identity is especially important if more than one tow notification service provider independently operates in a given area so as to ensure that the proper repository is notified.

The repository is an entity or operating component of an entity having or having access to a database containing information correlating vehicle identifier information with contact information for one or more persons associated with that vehicle. In accordance with one embodiment of the present invention the repository is a public sector entity or component thereof. For example, the repository may be a municipality, a division or operating component of a municipal entity, e.g., traffic control of the local police department, or of a state entity, e.g., the department of motor vehicles. The system and process is especially useful for large cities where multiple agencies and/or multiple substations or precincts have towing authority or conduct towing operations as well as numerous private towing operators. Here, while there may be multiple entities involved, a single repository could serve and be accessible by all agencies within the city.

For optimal performance and operation by the public sector, especially given the limited reach of each municipal entity or organization whereby each town, city, county, or state operates independently and, hence, acts as a separate repository, most preferably, each of these multiple repositories would be interconnected or capable of such interconnection so that a broader geographical region is covered by a given system. Alternatively, each repository could be connected to a central database, whereby all data is accessible to all member repositories of that database.

While the inventive system and notification process is certainly capable of being implemented and operated by a public sector entity or component thereof, it is more likely to be implemented in the private sector with or without, but most likely with, cooperation and participation by the public sector. One could see this as a stand-alone business or as another add-on to auto clubs like AAA. Here vehicle owners/operators would pay a periodic fee, e.g., an annual fee, for the service or the service could be provided as a pay-as-you-use service in which case one would only pay when the service is used or may pay an initial fee for joining the service and then a fee only upon use of the service. In any event, for this service to be most useful, cooperation and participation by the public sector is particularly important where the municipality or public sector conducts its own towing operations. Specifically, certain cities have their own fleet of tow trucks and multiple tow lots to which they tow vehicles. Consequently, for a private service provider to be effective, it must contract with said public entities to ensure that their tow operations are logged into the service providers' databases.

It is conceivable that the repository and the tow facility could be part of the same entity or organization. For example a large city that does its own towing operations could implement the present system and process as part of its towing operations as a whole. Similarly, where one or more private towing enterprises contract to provide towing services to a city or municipality, that or those private enterprises could implement the system and process, as an integrated system, as part of their operations. Generally, though, the repository will be an entity distinct from the tow facility, whether a public or private entity.

Transmitting the vehicle identifier information to the appropriate repository can be accomplished by any of a number of suitable first communication means. In its most technologically deficient embodiment, the tow facility, namely, the tow operator, the tow truck driver or another employee of the tow facility, merely makes a telephone call, wireless or landline, to the appropriate repository, as identified on the indicator, and verbally provides the appropriate vehicle identifier information together with the identity and contact information for the tow facility. Alternatively, the tow facility may manually transmit the identifier information together with the tow facility information in electronic form using a computer (especially a portable laptop computer, most preferably wireless), blackberry, I-phone, cell phone or the like, in an e-mail, over the internet by logging onto the website of the repository, via a text message, or the like.

Preferably, the first communication means is a wired or, most preferably, wireless scanner or reader having communication transmission properties or that is connected to a device having communication transmission properties. Scanners and readers, herein after collectively “scanners,” especially character and bar code scanners, are well known and readily available. Most preferably, the scanner is a wireless handheld device that the tow operator uses to scan the indicator to retrieve the identifier information for the vehicle, and, if present, the identity or contact information for the repository. The scanner may have a port for connecting to a separate communications device, e.g., a telephone, transceiver, computer, or the like to download and/or transmit the identifier information to the appropriate repository. When transmitting the identifier information for the vehicle to the repository, the electronic message could further include or have embedded in it the identity and/or contact information for the tow facility and/or a code assigned to said tow facility, all of which is further discussed below.

As noted above, the scanner most preferably also incorporates or is part of a communication means that is or is capable of electronic communication with the repository. For example, the hand held scanner may have phone and/or internet capability so that the scanner is directly able to call/connect to the repository. Additionally, the scanner may have or be part of a portable, handheld computer.

The scanner may have stored contact information for the repository so that upon scanning/reading the insignia on the indicator representative of the repository, it automatically establishes a communication link with that repository and sends the relevant vehicle identifier information. If the repository information is not capable of being scanned or recognized by the scanner, the scanner may have a keypad, touch screen or other like component that the operator engages and employs to make contact with the appropriate repository. For example, if there are multiple tow notification service providers, the scanner may have a keypad to dial the number for the appropriate repository or it may have pre-programmed buttons or sequence of buttons that, when pushed, will make a connection with the appropriate repository. Alternatively, a given scanner may be a dedicated scanner that is preprogrammed to make contact with the associated repository.

Alternatively, the scanner may be hard wired or, preferably, wirelessly connected with a telephone or computer system at the tow facility whereby, the scanned information is either transmitted wirelessly to the telephone or computer system and then retransmitted, automatically or manually, to the repository or once the connection is made with the repository, a transmit button is pushed on the scanner that begins to transmit the identifier information retrieved from the indicator, similar to the operation process of a facsimile machine.

Preferably, the scanner is a handheld device wherein the scanning capability is secondary to the primary function of the handheld device. Specifically, for those tow facilities that have an electronic or computerized tow management and record keeping system, the handheld device's primary purpose may be to enter data into that tow management system. In this instance the device is most preferably a portable, wireless keypad and/or computer, with scanner, upon which information pertaining to the towed vehicle is entered directly into the tow facility's tow management system for record keeping purposes. Devices having such capabilities are known and could readily be adapted and/or reprogrammed to operate in the present invention and process. For example, similar devices are used by car rental agencies to log and check out renters returning cars in the return lot rather than requiring them to go into the kiosk or rental counter to check out.

Yet another alternative scanner and first communication device is a digital camera, which may have photo, video or both capabilities. The digital camera may be a dedicated camera or it may be a cell phone or other communication device having photo and/or video capabilities. Unlike the previously mentioned scanners that read or scan the symbols, logos, characters or bar codes of the indicator, the digital camera takes a photo or video of the indicator so as to retrieve the identifier information. For example, a photo may be taken of the license plate or the VIN of the towed vehicle. The image is then read or interpreted by the digital camera or, more likely, a computer at the tow facility in electronic communication with the digital camera, which, in turn transmits the identifier information to the repository. Alternatively, the tow facility may merely transmit the image or video which is then read or interpreted by the computer at the repository, which then commences the collation process to collate the proper contact person. In the latter, a cell phone may be sufficient and will serve as both the camera and the first communication device. It is also contemplated that the tow facility may record multiple images or a video of the whole or portions of the vehicle as proof of the condition of the vehicle upon towing. These images or video may be stored at the tow facility, most often in it tow management system, or it could be forwarded to the repository. Alternatively, or in addition to the foregoing, images or video of the vehicle or portions thereof, especially the license plate or VIN, could be recorded to provide verification of the tow of the vehicle. The verification image(s) or video may then be transmitted to the repository together with the identifier information or the image of the indicator and further transmitted to the appropriate contact person as part of the tow alert notification.

While the foregoing discussion contemplates the digital camera as being the means for retrieving the identifier information, it is also contemplated that a digital camera or device having such capability, especially a cell phone, may be used in conjunction with and/or concurrent with the means by which the identifier information is retrieved. In this case, the tow facility may retrieve the identifier information by any of the other devices and means or methods for retrieving the identifier information as discussed in this specification; however, when the identifier information is transmitted to the repository, the information will be supplemented with, e.g., as an attachment, or have embedded therein the images of the vehicle or portions thereof taken with the digital camera or device so as to provide verification of the towing of the vehicle. Again, as noted above, this verification could then be forward with the tow alert notification to the appropriate contact person(s).

While each of the foregoing embodiments has been discussed with respect to the retrieval of the identifier information from the vehicle by the tow operator at the tow facility, it is to be understood that the retrieval and transmission step for the vehicle identifier information could be performed at the time of the tow operation, for example when the vehicle is being attached to or loaded onto the tow truck. Here, the first communications device is preferably a handheld, portable wireless communications device, most preferably a scanner device, all as discussed above. In this instance, the contact person could be notified of the tow before they become aware that the vehicle is missing, even before it arrives as the tow facility.

In yet another alternative embodiment of the present invention, the indicator may be a transmitter, receiver/transmitter, transponder, or like electronic device, hereinafter an “electronic indicator,” that is installed in or on the vehicle and is capable of transmitting an electronic signal comprising or indicative of the vehicle identifier information. This electronic indicator may continuously broadcast or transmit the identifier information or it may be in a standby mode whereby upon receipt of another signal, it then awakens to transmit the identifier information.

In this embodiment, the facility to which the vehicle is towed, most preferably, the entry to that facility, will have a compatible transmitter, receiver/transmitter, transponder, or like electronic device, hereinafter a “compatible electronic device,” which, as the vehicle is towed into the facility, receives the signal from the towed vehicle, or if the electronic indicator on the towed vehicle is in a stand-by mode, the facility transmitter broadcasts to the area of the facility entry a signal that activates the electronic indicator on the vehicle to then transmit the identifier information. The electronic signal containing the identifier information is then received by the compatible electronic device at the tow facility entry or by another receiver located in the tow facility. So as to alert the tow facility to the presence of the electronic indicator on the towed vehicle, the vehicle may also have another indicator, with our without the identifier information, that alerts the tow operator to the vehicle coverage by the tow notification service and/or the presence of the electronic indicator. For example, the vehicle may have a sticker, decal, trim piece or other insignia that indicates the vehicle is covered by a tow alert notification service.

Rather than a fixed or stationary compatible electronic device, as contemplated above, the tow facility may employ a hand-held compatible electronic device that effectively operates the same as the aforementioned stationary device. In this case, the electronic indicator could be activated and/or its signal captured at the time of the towing so that the tow alert notification is sent before the vehicle actually reaches the tow facility. Generally though, especially depending upon the range of the compatible electronic device, it is preferred to limit its operation to the tow facility in order to avoid picking up signals from other vehicles having such electronic indicators located in proximity to the vehicle to be towed. It should also be appreciated that in order to avoid false tow alerts, the compatible electronic device is preferably engaged at an entry that is exclusive to the tow truck and towed vehicle or is only activated when a tow truck enters the facility. Otherwise, one would have to take care that a vehicle having an indicator did not falsely activate the transmitter upon entry into the tow facility, e.g., when the contact person or their designee arrives to retrieve their towed vehicle in another vehicle that also has an electronic indicator.

While many configurations are possible for avoiding false alerts, a simple configuration is to configure the electronic transmitter/receiver system at the entryway to the tow facility such that the inward passing of the tow truck temporarily activates the compatible electronic device which then captures the electronic signal of the towed vehicle. For example, a scanner with bar code reader could be used to read a bar code on the side of the truck to activate the compatible electronic device or the tow truck may have an automatic or manually operated transmitter with activates the compatible electronic device at the entryway. Once activated, the compatible electronic device would only operate for a brief period of time, perhaps a few seconds or so: long enough to capture the signal from the electronic indicator on the vehicle as it passes through the entryway. Similarly, one could use directional transmitters/receivers so that only electronic signals across the entryway are enabled/registered by the compatible electronic device. Alternatively, the tow facility could also construct a stand alone gate on its premises through which the vehicle carrying or towing the towed vehicle passes to activate and/or capture the electronic signal from the electronic indicator device of the towed vehicle.

Again, devices and systems that are capable of performing the functions noted above or that can be readily adapted to perform those functions are well known. For example, cell phone technology, especially that aspect of cell phone technology whereby transmitters/receivers recognize or detect the entry of a cell phone into a defined geographic area and subsequently control the operation of that cell phone, could readily be adapted for this purpose. Such technology is disclosed in, for example, US 2006/0063563 A1—Kaufman; US 2006/0035649 A1—Vargas; US 2005/0107093 A1—Dowling, and U.S. Pat. No. 6,675,002 B1—Lipovski, all of which are incorporated herein by reference. Similarly, those skilled in the art will recognize other technologies which would readily accommodate the present invention including short-range wireless communications systems, pager technology, the Lo-Jack vehicle recovery system, etc. Perhaps the most applicable technology readily amenable to adapting to this aspect of the present invention is that pertaining to automatic tolls which register information from a transponder in the vehicle as it passes through the toll both.

Regardless of what means or device is employed to send the vehicle identifier information to the repository, whenever the vehicle identifier information is transmitted to the repository electronically, the electronic or digital information will include information pertaining to the identity, location and/or contact information for the tow facility. Most preferably, the information pertaining to the tow facility will be in the form of a code, number, or other identifier that is associated with the specific tow facility including, for example, the URI (Uniform Resource Identifier), URN (Uniform Resource Name), and/or the URL (Uniform Resource Locator) for the tow facility. In this case, the database will not only match up the vehicle identifier information with the contact person but will also match up the tow facility code with the appropriate tow facility information.

The repository will have or have access to a database that contains, at a minimum, information that correlates the vehicle identifier information with the identity and contact information for one or more persons associated with the vehicle. While it is conceivable that the database is a tangible database, paper records or the like, it is most preferably a computerized or electronic database. The contact information contained in the database may include at least one of the residence telephone number, work number, cell phone number, pager number, blackberry address, I-phone number, e-mail address, text message address and the like of the contact person or persons. The database will most likely also contain information pertaining to the identity of the contact person or persons and their residence address. It may also contain information pertaining to the vehicle, make, year, model, and/or VIN. Most preferably, the contact information will be of a type that allows for immediate transmission of the tow alert notification with a high likelihood of immediate or prompt receipt and reading. Finally, as mentioned above, the database may also include information on the tow facilities or operators, especially information correlating a tow facility identifier with information such as the identity, telephone number, and/or address of the tow facility, any one or more or all of which may be included in the tow alert notification to the contact person. Furthermore, while the foregoing information may be in normal character form, i.e., written or typed out in text, it may also be presented in electronic index form, that is as the URI (Uniform Resource Identifier), URN (Uniform Resource Name), and/or the URL (Uniform Resource Locator) for the tow facility. Similarly, rather than having the full address written out or presented, the location may be presented as the Mapquest or like company URL address for the locater map for the tow facility. In addition to the foregoing, the database may include information such as the fees, rates, hours and days of operations, acceptable payment methods and the like.

In any event, upon receipt of the vehicle identifier information, the repository will access the database and correlate the vehicle identifier information with the appropriate contact information. Typically, this will create or open a new file or record where the contact information and appropriate tow facility information are assembled. Concurrently, the repository or their computer will typically assign a service or customer number or identifier for this record. This information is then employed by the repository to generate an alert notice to be sent to the contact person to advise them of the towing of the vehicle. Like the initial steps of this notification system, the correlation and alert notification can be effected manually or electronically or by some combination or hybrid thereof.

In the manual mode, the identifier information can be correlated manually by a person working at the repository who then verbally, via a telephone call, or electronically, via an e-mail, text message, chat, video, blackberry message, or the like, notifies the contact person of the towing of the vehicle and of contact information for the tow facility or of the repository which can then provide further information concerning the tow facility.

Most preferably, though, much if not all or essentially all of the operations of the repository may be performed automatically. For example, the identifier information in electronic form may be received by a computer at or designated by the repository which computer then accesses the database containing the records of the customers of the tow notification service, particularly if operated by a private enterprise, or the vehicle registration or ownership records, especially if operated by a public sector entity. If the vehicle identifier information from the tow facility is not received in electronic form, then a person at the repository will manually enter the information into the repository computer system. The records and information are then correlated to match the vehicle identifier information with the contact information for one or more contact persons associated with the vehicle. The information is further matched or combined with the tow facility information and then the computer automatically generates and sends an alert notification to the appropriate contact person(s). For example, the computer of the repository could have a voice generation system such that once the appropriate information is collated, it generates a voice message and then calls the phone of the contact person and either delivers the message to the person answering the phone or leaves a message if voice mail is enabled. If not, the system can be programmed to automatically, periodically attempt to make contact until a live person answers or a message is left. In another embodiment, the computer system will generate an electronic tow alert message that is sent to the appropriate contact person(s) via e-mail, pager, blackberry or as a text message to a cell phone or other communications device. In another embodiment, a video alert is sent to a cell phone or display device. The latter systems can be programmed to periodically resend the message until it is acknowledged. Again, as noted, this alert may be a full notification of the tow and the tow facility contact information or it may be a simple tow alert with a contact number.

In an especially beneficial embodiment the notification process is fully automated. Here, the indicator will be an electronic device that issues or is activated to issue a signal indicative of the vehicle identifier information, which signal is received by a receiver at the tow facility, most likely at the entryway to the tow facility, which automatically contacts and transmits the vehicle identifier information to the repository. The receipt of the information by the repository automatically initiates a data retrieval and collation process whereby the vehicle identifier information is matched with the contact information for the vehicle. When the match is made, the contact person is then automatically contacted or sent a message regarding the towing of the vehicle.

The tow alert notification may be in the form of an electronic message, an e-mail, a text message, an audible message, an image or video, or the like. The content of the tow alert notification may be as simple as a contact number, which may be the contact number for the repository or the tow facility. Alternatively, the tow alert may further include information pertaining to the identity, telephone number, and/or address for the tow facility. As noted above, such information may be in long form or it may be in an electronic index form such as the URI (Uniform Resource Identifier), URN (Uniform Resource Name), and/or the URL (Uniform Resource Locator) for the tow facility. The alert notification may also include the URL address for the Mapquest or like service location of the tow facility or the message, upon receipt by the contact person, may automatically open up the Mapquest directions and/or map. Most preferably, the alert notification will include an indication that the notice pertains to a towing so that the recipient will pay attention to the same. Furthermore, it is preferred that the alert notice include a service or customer number or identifier so that the proper records can be quickly identified upon making the call to the tow facility or repository and/or when arriving at the tow facility to retrieve the vehicle. Finally, as noted above, the tow alert notification may also include one or more images of the vehicle or portions thereof as verification of the towing of the vehicle.

The tow notification system of the present invention may operate independently or it may be part of or integrated into a tow facility management operating system. Tow facility management operating systems are known, for example, one system that may be integrated with or supplemented by the system and process of the present invention is set forth in US 2002/0065703 A1—Barg, which is incorporated herein by reference. In this embodiment, the retrieval of the vehicle identifier information takes place concurrent with the tow facility's entry of the tow data into its own management system. Furthermore, while the foregoing discussion has focused on the transmission of the vehicle identifier information from the tow facility to the repository, it is also contemplated that the data retrieved during the correlation process could, in turn, be transmitted back to the tow facility to enable it to complete its record keeping on the towed vehicle. For example, as noted earlier, the database could include information concerning the owner or registrant for the vehicle as well as other information pertaining to the vehicle itself, e.g., year, make, model, etc. that is automatically downloaded into the tow facility electronic record and, is so programmed, populated into the data entry fields of its electronic tow management system.

As is self-evident from the foregoing discussion, essentially any communications device can be employed as the second communications device of the system of the present invention for sending the alert notification from the repository to the contact person(s). As noted above, the second communications device may be a telephone, cell phone, computer, electronic communication link, blackberry, I-phone, central pager, or the like. The selection of the specific second communication will depend upon the capabilities of the repository. For example, again as noted above, an employee of the repository could place a telephone or cell phone, send a text message, page, send an e-mail, etc., to the contact person(s). Alternatively, the computer system of the repository could be constructed and programmed to do those same functions.

As mentioned above, in its broadest embodiment, the tow notification process of the present invention comprises the steps of:
a) retrieving identifier information from an indicator on a vehicle that has been, is in the process of being or is about to be towed,
b) transmitting the identifier information to a repository having or having access to a database containing correlation information for matching the identifier information to one or more contact persons for the vehicle,
c) correlating said identifier information with the contact information for the one or more contact persons, and
d) sending an alert to at least one of said contact persons wherein said alert either contains at least one of the identity, location or contact number of the facility to which the vehicle has been towed or contains a contact number to be called to so that the aforementioned information can be retrieved. Most preferably, the alert will include some indication that a towing has occurred so that the recipient of the alert will pay, or will have a greater likelihood of paying, attention to the same as well as a service or customer number or identifier for that particular tow operation.

Where the repository is not the place to which the vehicle has been towed, information pertaining to the tow facility conducting the tow and/or the location to which the vehicle is being or has been towed will also be transmitted to the repository together with the vehicle identifier information. Such information may be a code associated with that tow facility or the identity, telephone number and/or address of the tow facility, all as described above. Where the tow alert notification is or contains a contact number, the contact number may be for the tow facility, the repository or their designee.

As noted above, the process of retrieving the identifier information may be performed manually by visual inspection of the indicator. The identifier information may then be transmitted to the repository verbally via a phone call or manually using a computer or a cell phone, blackberry or comparable device having a keypad. Alternatively, the identifier information may be scanned manually, e.g., using a handheld scanner, and then sent electronically to the repository. In yet another alternative, the retrieval of the identifier information may be performed automatically through the transfer of electronic signals between an electronic device located on the vehicle and a compatible device located at the tow facility, most preferably at the entry to the tow facility. The latter process may be accomplished in a manner similar to and by use of devices employed in the operation of an automatic toll (speed pass) type system. Furthermore, as discussed above, when transmitting the identifier information to the repository, the transmitted information may be supplemented with or have embedded therein a code or other information pertaining to the identity, contact information and/or address for the tow facility.

At the repository, the information transmitted by the tow facility is then collated with information contained within a database located at or accessible to the repository. Such collation process may be done manually by persons at the repository who access written or printed records or, preferably, who program or key the information into an electronic database. Alternatively, and preferably, the collation process is performed automatically through computer means programmed to automatically accept the transmitted identifier information and initiate the collation process to match it to information in the database so as to identify/retrieve the contact information for the contact person(s) for the vehicle. The contact information will be further collated with information pertaining to the identity, contact information and/or address for the tow facility.

Once the collation has been completed, a report may issue to a person at the repository who then sends an alert notification to the contact person. The alert notification may be sent via a phone call, phone message, e-mail message, text message, and the like. Alternatively, the computer system of the repository may be programmed to automatically send the alert notification through the same communications channels. Automated voice messaging programs, e-mail and text generating programs and the like are well known and widely available and can be readily adapted for use in the practice of the present invention.

In addition to sending the aforementioned alert notification to the contact person for the vehicle, the repository, either manually or automatically, could likewise send information from the database pertaining to or about the towed vehicle to the tow facility so that it can properly record information such as ownership information, contact information, vehicle information, and the like. Such information could be send verbally, in written or fax form, or it could be sent electronically. If the latter, the information could be directly downloaded or downloadable into the tow facility's automated tow management system. Having completed or nearly completed records at the tow facility when the contact person or their designee arrives to retrieve the vehicle has the added benefit of speeding up and simplifying the retrieval process.

Without further elaboration, it is believed that one skilled in the art, using the preceding description, can utilize the present invention to its fullest extent. Furthermore, while the present invention has been described with respect to aforementioned specific embodiments and examples, it should be appreciated that other embodiments, changes and modifications utilizing the concept of the present invention are possible, and within the skill of one in the art, without departing from the spirit and scope of the invention. The preceding preferred specific embodiments are, therefore, to be construed as merely illustrative, and not limitative of the remainder of the disclosure in any way whatsoever.

We claim:

1. A tow notification system comprising
a) an indicator on a motor vehicle indicative of identifier information pertaining to one or more contact persons associated with the vehicle,
b) a repository possessing a database containing correlation information matching the identifier information with the contact information for the contact persons,
c) a first communication means for transmitting the identifier information to the repository when said vehicle is or is about to be towed, and
d) a second communicating means for alerting the contact person to the towing of the motor vehicle.

2. The tow notification system of claim 1 wherein the indicator is the vehicle registration number or the vehicle identification number.

3. The tow notification system of claim 1 wherein the indicator is a sticker, decal, trim piece, or equivalent device applied to the vehicle that has a unique identifier for that vehicle.

4. The tow notification system of claim 3 wherein the unique identifier is selected from a numerical identifier, an alphabetical identifier, an alpha-numerical identifier, a bar code or any combination thereof.

5. The tow notification system of claim 1 wherein the indicator is an electronic transmitter which transmits an electronic identifier signal unique to the vehicle and the first communication means comprises an electronic signal receiver capable of receiving the electronic identifier signal.

6. The tow notification system of claim 1 wherein the first communication means comprises an electronic signal transmitter and receiver and the indicator is an electronic signal transmitter and receiver which, upon receipt of a first signal from the first communication means, activates the transmitter of the indicator to then transmit the identifier information to the first communication means which then transmits the identifier information to the database.

7. The tow notification system of claim 1 wherein the contact person is the owner or registrant of the vehicle.

8. The tow notification system of claim 1 wherein the database is maintained by a public or private entity and the identifier information comprises contact information pertaining to that public or private entity as well as information pertaining to the owner or registrant of the vehicle.

9. The tow notification system of claim 1 wherein the database is maintained by a private pay-for-service entity and the identifier information comprises contact information pertaining to that entity as well as contact information pertaining to the owner or registrant of the vehicle or the person or their designee who has registered the vehicle with that entity.

10. The tow notification system of claim 1 wherein the first communication means comprises a manual data input means whereby the operator of the first communication means can input the identifier information from the indicator.

11. The tow notification system of claim 1 wherein the first communication means comprises a hand-held scanner that scans the identifier information from the indicator.

12. The tow notification system of claim 1 wherein the first communication means comprises an electronic signal receiver that receives an electronic signal containing the identifier information from the indicator.

13. The tow notification system of claim 12 wherein the electronic signal receiver is positioned at the entry to the facility to which the vehicle has been towed.

14. The tow notification system of claim 1 wherein the first communication means comprises an electronic signal transmitter and receiver that transmits an electronic signal that is received by the indicator causing the indicator to then issue an electronic signal containing the identifier information for the vehicle.

15. The tow notification system of claim 14 wherein the electronic signal transmitter and receiver is positioned at the entry to the facility to which the vehicle has been towed.

16. The tow notification system of claim 1 wherein the first communication means also transmits identifier information to the database pertaining to the identity or location of the facility to which the vehicle is being or has been towed.

17. The tow notification system of claim 1 wherein the database includes at least one of the following contact information for the contact person: a land-line phone number, a cell phone number, a pager number, an e-mail address, and a blackberry address.

18. The tow notification system of claim 1 wherein the second communication means is capable of sending a message to at least one of a land-line phone number, a cell phone number, a pager number, an e-mail address, and a blackberry address.

19. The tow notification system of claim 18 wherein the message comprises a call-back number.

20. The tow notification system of claim 18 wherein the message indicates that the vehicle has been towed and includes information pertaining to the identity, contact information or location of the facility to which the vehicle has been towed.

21. A method of notifying a contact person of the towing of a vehicle said method comprising
a) retrieving identifier information from an indicator on the vehicle
b) transmitting the identifier information to a repository having or having access to a database containing correlation information for matching the identifier information to one or more contact persons for the vehicle,
c) correlating said identifier information with the contact information for the one or more contact persons, and
d) sending an alert to at least one of said contact persons wherein said alert either contains at least one of the identity, location or contact number of the facility to which the vehicle has been towed or contains a contact number to be called to so that the aforementioned information can be retrieved.

22. The method of claim 21 wherein the alert sent to the contact person(s) includes an indication that a towing has occurred.

23. The method of claim 21 wherein the indicator is a visual indicator and the identifier information is retrieved visually and manually keyed or verbally transmitted to the repository.

24. The method of claim 21 wherein the indicator is a visual indicator and the identifier information is scanned and transmitted electronically to the repository.

25. The method of claim 21 wherein the repository comprises or employs a computer that accesses the database and collates the identifier information with the contact information.

26. The method of claim 21 wherein the indicator is a visual indicator and the identifier information is scanned and transmitted electronically to a computer at the repository which then collates the identifier information with contact information in the database to match the identifier information with a contact person.

27. The method of claim 21 wherein the alert notification is sent to the contact person via a telephone message, an e-mail, a text message, a blackberry message, chat, video, or a page.

28. The method of claim 21 wherein the method is fully automated.

29. The method of claim 28 wherein the indicator is an electronic signal transmitting device which generates an electronic signal containing or comprising the identifier information which signal is received by an electronic transmitter which, directly or indirectly, transmits the identifier information to the repository, which repository comprises a computer that automatically collates the identifier information with the contact person information in the database and which subsequently, automatically, sends an alert notification to the contact person regarding the towing of the vehicle.

30. The method of claim 29 wherein the alert notification is sent via e-mail, telephone, text message, page, or blackberry message.
